(19) United States
(12) Patent Application Publication
(10) Pub. No.: US 2007/0296657 A1
(43) Pub. Date: Dec. 27, 2007

(54) FLICKER CONTROLLING SYSTEM FOR LIQUID CRYSTAL DISPLAY DEVICE

(75) Inventors: Kouichi Ooga, Kanagawa (JP); Tsuyoshi Ichiraku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 11/621,259

(22) Filed: Jan. 9, 2007

(30) Foreign Application Priority Data
Jan. 10, 2006 (JP) 2006-002258

(51) Int. Cl. G09G 3/36

(52) U.S. Cl. 345/87

(57) ABSTRACT

A liquid crystal display device is provided which is capable of preventing occurrence of accidental abnormal flicker control caused by calibrating work being not related to the flicker controlling operation. The liquid crystal display device so configured that its flicker controlling system performs the flicker controlling operations on a liquid crystal displaying section by using a flicker controlling screen corresponding to a driving method for the liquid crystal displaying section is made up of an input signal pattern judging section which outputs a specified signal when judging that data for the flicker controlling screen is contained in a signal input to the liquid crystal displaying section, a COM (Common) potential controlling section which outputs a voltage adjusting signal to control a common electrode potential of the liquid crystal displaying section, and a COM potential outputting section which sets a common electrode potential of the liquid crystal displaying section.

### BACKGROUND OF THE INVENTION

1. Field of the Invention

The present invention relates to a flicker controlling system for a liquid crystal display device (LCD) in which a flicker controlling operation is allowed only when it is judged that image data to display a flicker controlling screen (FCS) is contained in an input signal, only when it is judged that FCS data is contained in an input signal and the FCS data is input with normal timing, and only when it is judged that the FCS data is contained in the input signal and the data to display the flicker controlling screen is input with normal timing and particular signals match product specifications of the LCD.

The present application claims priority of Japanese Patent Application No. 2006-002258 filed on Jan. 10, 2006, which is hereby incorporated by reference.

2. Description of the Related Art

In an LCD which allows flicker to be controlled, a flicker controlling operation is performed during manufacturing processes of the LCD. Various methods for controlling flicker are proposed, and one typical method of which is to perform the flicker controlling operation by using a flicker controlling screen displayed on a screen of the LCD.

FIG. 2 shows an example of a conventional flicker controlling system to set an optimum common electrode potential (COM potential) to a common electrode (not shown) in a liquid crystal displaying section 11. A signal for voltage adjustment is fed from the outside through a switch jig or a like to the COM potential controlling section 12 and the COM potential controlling section 12 changes a common electrode voltage to be supplied by the COM potential outputting section 13. At this time point, an operator, while observing a flickering state on a FCS displayed in the liquid crystal displaying section 11, sets a COM potential so that flickering is minimized, by adjusting a value of a common electrode voltage adjusting signal to the COM potential outputting section 13. The value of a voltage adjusting signal corresponding to a COM potential which minimizes flicker is stored in a memory (not shown) of the COM potential controlling section 12. Consequently, after the operator completed the flicker controlling work and the switch jig is detached, the voltage adjusting signal having the value already stored in the COM potential controlling section 12 is output which enables a COM potential for minimizing flicker to be maintained in the liquid crystal displaying section 11.

A conventional LCD being able to perform a flicker controlling operation and a conventional method for controlling flicker are disclosed in, for example, Patent Reference 1 (Japanese Patent Application Laid-open No. 2002-149123). The disclosed LCD has a liquid crystal panel in which a liquid crystal material is injected between two plates of common electrodes and a plurality of pixel electrodes arranged in a matrix form and in a manner to face the common electrodes so that each pixel electrode can be controlled. The disclosed LCD is driven according to a reversion driving method in which a driving voltage to be applied inversely in every determined period between the common electrodes and pixel electrodes. At time of a flicker controlling operation in manufacturing processes of an LCD, a FCS is displayed on a display section of the LCD. An operator changes a level meter stepwise by manual for adjusting a flicker controlling volume to the switch jig, while monitoring visually a degree of flickering on a flicker controlling horizontal-stripes pattern displayed on the FCS and finishes the flicker controlling operation when flicker is minimized. At this time point, a value of the level meter is stored in a memory of a controlling circuit in the LCD. At time of operations of the LCD thereafter, a central potential level of a voltage to be applied to the common electrodes and pixel electrodes according to the value of the level meter stored in the controlling circuit is adjusted. Thus, by re-creating the adjusting state based on the central potential level at time of subsequent flicker controlling operation, it is made possible to display a screen being able to minimize flicker at all times.

Also, a conventional method for automatically improving flicker on a screen of an LCD is disclosed in Patent Reference 2 (Japanese Patent Application Laid-open No. 2002-196735). According to the above automatic flicker improving method, a flicker level on a displayed screen is detected to generate a detecting voltage Sp and then the detecting voltage Sp is compared with a predetermined voltage Sf. When the detecting voltage Sp is higher than that of the predetermined voltage Sf, a flicker improving inversion technology is automatically switched from one of flicker inversion methods to the other method such as dot-inversion method, line-inversion method, column-inversion method, or n line-inversion method that has been employed previously to the remaining any one of the other inversion methods that has not been employed yet.

Also, a conventional LCD capable of automatically eliminating the flicker is disclosed in Patent Reference 3 (Japanese Patent Application Laid-open No. 2004-264677). In the disclosed LCD, a liquid crystal material is injected between common electrodes and pixel electrodes disposed facing the common electrodes. The pixel electrodes each make up a plurality of dummy pixels in a region surrounding the image displaying portion in the pixel electrodes. Then, it detects a potential difference between a common voltage and a dummy pixel electrode voltage equivalent to a gray level voltage with a positive polarity, as applied to one group of dummy pixels, and also a potential difference between the common voltage and a dummy pixel electrode voltage equivalent to a gray level voltage with a negative polarity, as applied to another group of dummy pixels. A control circuit controls the common voltage so that both the potential differences are equal to each other.

Furthermore, a projector for generating modulated light by using an LCD which is capable of eliminating flicker occurring on an image projected from the projector is disclosed in Patent Reference 4 (Japanese Patent Application Laid-open No. 2005-221569). In the disclosed projector, a luminance sensor to detect luminance of modulated light is provided. The luminance sensor detects luminance of modulated light emitted from an LCD according to a facing electrode voltage adjusted based on a set parameter value. Then, the parameter value is set successively to a plurality of values and a flicker value is calculated according to a difference between maximum and minimum values a of luminance signal detected by the luminance sensor corresponding to each value to which the parameter is set and a parameter value at which a flicker value is minimized and then a facing electrode voltage value to be input to a liquid crystal panel is adjusted to remove flicker on a projected image.

However, the above conventional technologies have problems. That is, in some cases, during processes of manufacturing an LCD, an unexpected change occurs in an adjusted flicker controlling state, that is, an unexpected change in a preset value for flicker controlling caused by an operator's mistakes during other adjusting work being not related to flicker control operations for the LCD and by an accidental conditions, abnormal changes of the flicker controlling state during the use of the LCD, occurrence of shocks to the device, accidents or a like.

### SUMMARY OF THE INVENTION

In view of the above, it is an object of the present invention to provide a flicker controlling system which is capable of preventing an accidental change in a preset flicker controlling value in an LCD caused by an operator's mistakes during other adjusting work, occurrence of shocks to the device, and accidents or a like.

According to a first aspect of the present invention, there is provided a flicker controlling system of an LCD for performing a flicker controlling operation on a liquid crystal displaying unit by using an appropriate FCS corresponding to a driving method for the liquid crystal displaying unit, including:

an input signal pattern judging unit to output a specified signal when judging that data to display the FCS is contained in a signal input to the liquid crystal displaying unit;

a COM (Common) potential controlling unit to output a voltage adjusting signal for controlling a common electrode potential of the liquid crystal displaying unit according to the specified signal and, thereafter, to maintain an outputting state of the voltage adjusting signal; and

a COM potential outputting unit to set a common electrode potential by supplying a common electrode voltage according to the voltage adjusting signal.

According to a second aspect of the present invention, there is provided a flicker controlling system of an LCD for performing a flicker controlling operation on a liquid crystal displaying unit by using a FCS corresponding to a driving method for the liquid crystal displaying unit, including:

an input signal pattern judging unit to output a specified signal when judging that data to display the FCS is contained in a signal input to the liquid crystal displaying unit and that input timing of data to display the FCS matches predetermined timing;

a COM potential controlling unit to output a voltage adjusting signal for controlling a common electrode potential of the liquid crystal displaying unit according to the specified signal and, thereafter, to maintain an outputting state of the voltage adjusting signal; and

a COM potential outputting unit to set a common electrode potential by supplying a common electrode voltage according to the voltage adjusting signal.

According to a third aspect of the present invention, there is provided a flicker controlling system of an LCD for performing a flicker controlling operation on a liquid crystal displaying unit by using a FCS corresponding to a driving method for the liquid crystal displaying unit, including:

an input signal pattern judging unit to output a specified signal when judging that data to display the FCS is contained in a signal input to the liquid crystal displaying unit and that input timing of data to display the FCS matches predetermined timing, and that specifications of the liquid crystal displaying unit match product specifications of the LCD;

a COM potential controlling unit to output a voltage adjusting signal for controlling a common electrode potential of the liquid crystal displaying unit according to the specified signal and, thereafter, to maintain an outputting state of the voltage adjusting signal; and

a COM potential outputting unit to set a common electrode potential by supplying a common electrode voltage according to the voltage adjusting signal.

In the foregoing first, second or third aspect, a preferable mode is one wherein, in the COM potential controlling unit, a switch to set the voltage adjusting signal to be in an output state is attached to a jig and tool mounted in the LCD.

Also, a preferable mode is one wherein, in the COM potential controlling unit, a switch to set the voltage adjusting signal to be in an output state is attached to the LCD itself.

Also, a preferable mode is one wherein a driving method for the liquid crystal displaying unit is a frame-inversion driving method in which a polarity of an entire frame is alternately inverted in every one frame.

Also, a preferable mode is one wherein a driving method for the liquid crystal displaying unit is a line-inversion driving method in which a polarity of each line is alternately inverted on every line and in every one frame.

Also, a preferable mode is one wherein a driving method for the liquid crystal displaying unit is a dot-inversion driving method in which a polarity of each dot is alternately inverted on every dot and in every one frame.

Also, a preferable mode is one wherein a driving method for the liquid crystal displaying unit is a 1H2V (1 Horizontal line 2 Vertical lines)-inversion driving method in which a polarity of a driving voltage is alternately inverted for every one horizontal line and every two vertical scanning lines for every one frame period.

Furthermore, a preferable mode is one wherein a driving method for the liquid crystal displaying unit is a 2H1V (2 Horizontal lines and 1 Vertical line)-inversion driving method in which a polarity of a driving voltage is alternately inverted for every two horizontal lines and every one vertical scanning line for every one frame period.

With the above configurations, a change in an adjusted flicker controlling state, that is, a change in a preset value for flicker controlling caused by an operator's mistakes during other adjusting work being not related to flicker control operations for the LCD and by an accidental conditions, abnormal changes of the flicker controlling state during the use of the LCD, occurrence of shocks to the device, accidents or a like can be prevented.

### BRIEF DESCRIPTION OF THE DRAWINGS

The above and other objects, advantages, and features of the present invention will be more apparent from the following description taken in conjunction with the accompanying drawings in which:

FIG. 1 is a circuit diagram showing configurations of a flicker controlling system for an LCD according to a first embodiment of the present invention; and

FIG. 2 is a diagram showing configurations of a conventional flicker controlling system for an LCD.

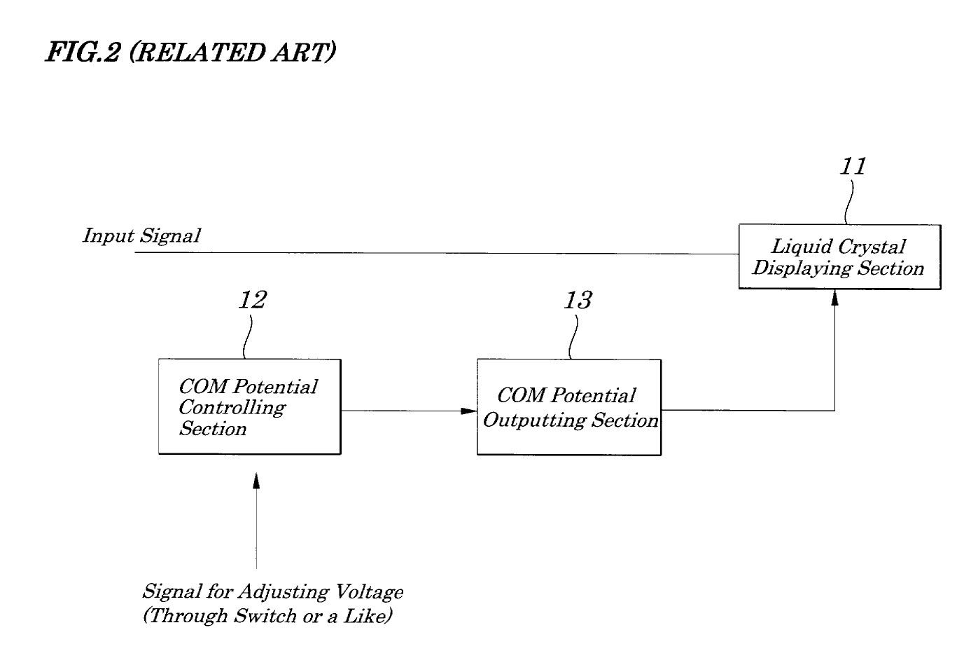

### DETAILED DESCRIPTION OF THE PREFERRED EMBODIMENTS

Best modes of carrying out the present invention will be described in further detail using various embodiments with reference to the accompanying drawings. An LCD so configured that its liquid crystal displaying means performs a flicker controlling operation by using a FCS corresponding to a driving method of the liquid crystal displaying means includes an input signal pattern judging means to output a specified signal when it is judged that data to display a FCS exists in a signal input to the liquid crystal displaying mean, a CON (Common) potential controlling means to output a voltage adjusting signal for controlling a common electrode potential of the liquid crystal displaying unit according to the specified signal and, thereafter, to maintain an outputting state of the voltage adjusting signal, and a COM potential outputting means to set a common electrode potential by supplying a common electrode voltage according to the voltage adjusting signal.

### First Embodiment

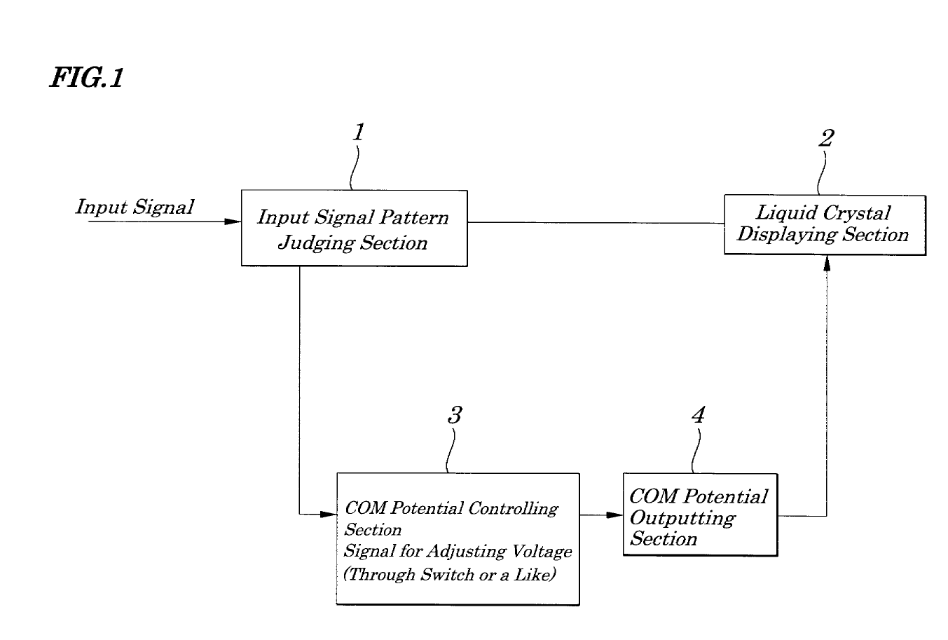

FIG. 1 is a diagram showing configurations of a flicker controlling system for an LCD according to the first embodiment of the present invention. The flicker controlling system for the LCD of the first embodiment, as shown in FIG. 1, chiefly includes an input signal pattern judging section 1, a liquid crystal displaying section 2, a COM potential controlling section 3, and a COM potential outputting section 4. In FIG. 1, a main body of the liquid crystal device is not shown, but only the liquid crystal displaying section 2 to display images in response to specified input signals is shown.

The input signal pattern judging section 1 judges whether or not a data contained in an input signal matches the data stored in advance in the input signal pattern judging section 1 and used for a FCS corresponding to a driving method employed for the LCD being presently operated and, when matching between them, outputs a specified signal indicating the match. The liquid crystal displaying section 2 displays an image in response to the input signal having passed through the input signal pattern judging section 1 in accordance with the driving method for the LCD. The COM potential controlling section 3, in response to the specified signal fed from the input signal pattern judging section 1, generates and outputs a signal to the COM potential outputting section 4 for adjusting a voltage required to supply a common electrode (not shown) voltage in the liquid crystal displaying section 2. The COM potential outputting section 4, in response to the signal for adjusting the voltage fed from the COM potential controlling section 3, outputs a voltage for setting a potential (COM potential) of the common electrode in an LCD (Liquid Crystal Display) panel mounted in the liquid crystal displaying section 2.

Operations of the flicker controlling system for the LCD of the first embodiment are described by referring to FIG. 1 below. The FCS is a screen to be used for controlling flicker in the LCD and is a specified screen determined according to a driving method employed for the LCD and, therefore, the screen is uniquely determined when a driving method to be used for the LCD is specified. Consequently, signal data to be used in the FCS when the LCD to perform a flicker controlling operation is stored in advance in the input signal pattern judging section 1 according to a type of the LCD and the input signal pattern judging section 1 judges whether or not a data contained in an input signal matches the signal data stored in advance. If it is judged by the input to a signal pattern judging section 1 that there is a match between them and that the LCD gets into a flicker-controllable state and a specified signal for generating a signal to be used for adjustment of a common electrode voltage is output from the input signal pattern judging section 1 to the COM potential controlling section 3. Ordinarily, a repetitive display pattern is used on the FCS for controlling flicker and, therefore, a memory that can store several pixels is sufficient as the memory required for storing data to be used for judging as to whether data to display a FCS has been input in the input signal pattern judging section 1.

More specifically, the input signal pattern judging section 1, when judging that data to display the FCS has been input therein, outputs a H-level signal and, when judging that the data to display the FCS has not yet been input, outputs a L-level signal. The COM potential controlling section 3, when receiving an H-level (High level) signal from the input signal pattern judging section 1, recognizes that the LCD is in a flicker-controllable state and outputs a signal for enabling to adjust the common electrode voltage to the COM potential outputting section 4 and, when receiving an L-level (Low-level) signal from the input signal pattern judging section 1, outputs no signal for adjusting the common electrode voltage to the COM potential outputting section 4. Thus, the COM potential outputting section 4 generates a variable voltage corresponding to a signal for adjusting the common electrode voltage. In only receiving the H-level signal, the LCD gets into a flicker-controllable state and supplies a common electrode voltage to the liquid crystal displaying section 2. This enables the liquid crystal displaying section 2 to change a COM potential and flicker to be controlled. In the cases other than this, a COM potential is maintained constantly at all times.

More specifically, when a H-level signal is input to the COM potential controlling section 3 and the LCD gets into a flicker-controllable state, and an electronic volume (not shown) for adjusting a COM potential in the COM potential controlling section 3 is possible to use it. Consequently, by changing a common electrode voltage output from the COM potential outputting section 4 according to a signal determined by setting the electronic volume, an operator can set a COM potential in the liquid crystal displaying section 2 at its optimum value and can control it so as to minimize the flickering. Moreover, when an L-level signal is input to the COM potential controlling section 3 and the liquid crystal display is in a state in which flicker cannot be controlled, by setting the electronic volume so as to get into a protected state, the adjustment of the electronic volume is nullified and, therefore, the control of flickering is made impossible.

In addition, a COM potential may be adjusted in the COM potential controlling section 3 by adjusting the electronic volume of the LCD using a switch jig or a like, or the electronic volume may be adjusted the COM potential within the LCD by using the switch jig mounted within the LCD. In this case, the switch is a jig having two buttons, a plus (+) button and a minus (−) button. The switch jig is so constructed that, when the plus (+) or minus (−) button is pressed, the pressed state is transferred to the electronic volume, thereby increasing (or decreasing) a COM potential by XmV every time the plus (+) or minus (−) button is pressed.

As described above, in the flicker controlling system for the LCD of the first embodiment, only when data to display the FCS is input to the liquid crystal displaying section 2 and is displayed and the LCD is in a flicker-controllable state, flicker can be controlled by adjusting a common electrode potential. Therefore, when the switch jig or a like is used for generating a signal, to be output to the COM potential outputting section 4, for voltage adjustment in the COM potential controlling section 3, a change in a flicker controlling state, that is, a change in a preset value for flicker controlling caused by operational mistakes during calibrating work being not related to flicker adjusting operations for the LCD or by malfunctions at time of detaching the switch jig after completion of flicker controlling operations can be prevented.

Furthermore, in the case where the switch for generation of a common-electrode voltage adjusting signal in the COM potential controlling section 3 is not attached to the jig or tool for the adjustment, but is mounted within a product of the LCD, there is a risk of an unexpected change after shipment of the product. However, according to the flicker controlling system for the LCD of the first embodiment, even in such the case, unless data for the FCS is already input to the input signal pattern judging section 1 and the LCD already is in a flicker-controllable state, flicker is not allowed to be controlled and, therefore, a change in a non-flicker controlling state, that is, a change in a preset value for flicker controlling, caused by an accidental condition or an abnormal flicker controlling state during the use of the LCD, occurrence of shocks to the device, or accidents can be prevented.

### Second Embodiment

In the above first embodiment shown in FIG. 1, the flicker controlling operation is made possible according to conditions defined only by data contained in an input signal. However, it is possible to control flicker according to two conditions defined by both input data and input timing data, which is realized in the second embodiment described below.

Circuit configurations of a flicker controlling system of the second embodiment are the same as shown in the first embodiment shown in FIG. 1 except that not only input data but also input timing data are simultaneously judged by the input signal pattern judging section 1 as to whether these two input data blocks meet the preset conditions for displaying a FCS and, only when preset conditions are satisfied by the input data and input timing data, the flicker controlling operation is made possible. Moreover, the input timing of data for flicker control is determined in every product specification of an LCD proper and is stored in a timing controller of the LCD, however, there is no correlation between input timing with which data to display a FCS is input and timing employed in a driving method of the liquid crystal displaying section.

It is here presumed that, for example, the driving method is a dot-inversion driving method and the input timing frequency of flicker controlling data in product specifications of an LCD is 130 MHz. When a screen for flicker control is displayed, the screen is uniquely determined according to a driving method of the LCD. In the case of the dot-inversion driving method, the screen for flicker control is of a dot-checkered type. To display the screen in this state, normal timing input is required and, in this case, the timing frequency at which data is input is 130 MHz.

In some cases, however, even if data input timing controlled by a timing generator in the LCD is not normal, for example, even if data is input at a timing frequency of 120 MHz, an image is displayed normally by the liquid crystal displaying section 2. Such a phenomenon possibly occurs, for example, when a frame frequency is low. However, according to the second embodiment, unless the input timing frequency of flicker control data is normally 130 MHz, the flicker controlling operation cannot be started. At this time point, an alarm is given indicating that the input timing is not normal to alert an operator to the abnormal input timing and, therefore, occurrence of an event in which incorrect flicker control is exercised can be avoided.

As explained above, the flicker controlling system of the second embodiment is so configured as to change a common electrode potential to exercise flicker control only when the LCD gets into a flicker-controllable state and data for a FCS is input with normal input timing.

Thus, according to the LCD of the type to exercise the flicker control, as in the case of the first embodiment, when the switch jig or the like used to generate a signal for voltage adjustment in the COM potential controlling section 3 is used, a change in a flicker controlling state, that is, a change in a preset value for flicker controlling caused by operational mistakes during other adjusting work being not related to flicker control operations for the LCD or by malfunctions at time of detaching the switch jig after completion of flicker controlling operations can be prevented and even when the switch configured to generate a signal for voltage adjustment in the COM potential controlling section 3 is mounted within the LCD, unless data to display a FCS is already input to the input signal pattern judging section 1 and unless the LCD already gets into a flicker-controllable state, the flicker control cannot be started and, therefore, a change in a non-flicker controlling state, that is, a change in a preset value for flicker controlling, caused by an accidental abnormal flicker controlling state during the use of the LCD, occurrence of shocks to the device, or accidents can be prevented with reliability.

### Third Embodiment

In the above second embodiment, the flicker controlling operation is allowed only when not only the input data but input timing meets specified conditions. However, the flicker controlling system may be configured so that, when specifications of a liquid crystal displaying unit differ from product specifications stored in the LCD proper, the flicker controlling operation is not allowed. Such a case is described below. Circuit configurations of a flicker controlling system of the third embodiment are the same as shown in the first and second embodiment shown in FIG. 1 except that a flicker controlling operation is made possible only when it is judged by the input signal pattern judging section 1 that data contained in an input signal matches data stored in advance therein and not only input data but also input timing data meets the preset conditions for displaying a FCS and, additionally, specifications of a liquid crystal displaying unit meet predetermined product specifications of the LCD proper.

In the third embodiment, product specifications (such as timing) of an LCD in which a flicker controlling operation is to be performed is preset in a memory (not shown) within the input signal pattern judging section 1 and it is judged by the input signal pattern judging section that data to display a FCS has been input with required timing and specifications of a liquid crystal displaying unit are compared with the product specifications of the LCD proper stored in the memory. Only when there is a match between these two specifications, the COM potential controlling section 3 generates a signal for voltage adjustment and supplies it to the COM potential outputting section 4 to change a common electrode voltage to be output from the COM potential outputting section 4 to the liquid crystal displaying section 2 which causes a COM potential to be adjusted in the liquid crystal displaying section 2, thus enabling the flicker controlling operation.

Thus, according to the flicker controlling system of the LCD of the third embodiment, the flicker controlling operation is made possible and the LCD gets into a flicker-controllable state only when data to display a FCS is input and the data input timing and specifications of the product meet the preset values.

Thus, according to the LCD of the type to exercise the flicker control of the third embodiment, as in the case of the first and second embodiments, when the switch jig or the like used to generate a signal for voltage adjustment in the COM potential controlling section 3 is used, a change in a non-flicker controlling state, that is, a change in a preset value for flicker controlling caused by operational mistakes during other adjustment work being not related to flicker control operations for the LCD or by malfunctions at time of detaching the switch jig after completion of flicker controlling operations can be prevented and, even when the switch configured to generate a signal for voltage adjustment in the COM potential controlling section 3 is mounted within the LCD, unless the LCD already gets into a flicker-controllable state, the flicker control cannot be started and, therefore, a change in a flicker controlling state, that is, a change in a preset value for flicker controlling, caused by an accidental abnormal flicker controlling state during the use of the LCD, occurrence of shocks to the device, or accidents can be prevented with reliability.

It is apparent that the present invention is not limited to the above embodiments but may be changed and modified without departing from the scope and spirit of the invention. For example, as a driving method for an LCD panel in an LCD, a frame-inversion driving method may be used in which a polarity of an entire frame is inverted for every one frame period, or a line-inversion driving method may be used in which a polarity of each line is inverted alternately for every one frame period to display a screen in which a polarity of a driving voltage is inverted alternately for every one line, or a dot-inversion driving method may be used in which a polarity of each dot is alternately inverted for every one frame period to display a screen in which a polarity of a driving voltage is inverted for every one dot, a 1H2V (1 Horizontal line 2 Vertical lines)-inversion driving method may be used in which a polarity of each block is alternately inverted for every frame period to display a screen in which a polarity of a driving voltage is alternately inverted for every one horizontal (H) line and every two vertical (V) scanning lines, or a 2H1V (2 Horizontal lines 1 Vertical line)-inversion driving method may be used in which a polarity of each block is alternately inverted for every one frame to display a screen in which a polarity of a driving voltage is alternately inverted for every two horizontal (H) lines and every one vertical (V) scanning line.

The flicker controlling system of the LCD of the present invention can be applied to flicker controlling operations for a liquid crystal display of liquid crystal television sets or personal computers, for a liquid crystal displaying section of a car navigation system and PDA (Personal Digital Assistants) of various types.

What is claimed is:

1. A flicker controlling system of a liquid crystal display device for performing a flicker controlling operation on a liquid crystal displaying unit by using a flicker controlling screen corresponding to a driving method for said liquid crystal displaying unit, comprising:
an input signal pattern judging unit to output a specified signal when judging that data to display said flicker controlling screen is contained in a signal input to said liquid crystal displaying unit;
a common potential controlling unit to output a voltage adjusting signal for controlling a common electrode potential of said liquid crystal displaying unit according to said specified signal and, thereafter, to maintain an outputting state of said voltage adjusting signal; and
a common potential outputting unit to set a common electrode potential by supplying a common electrode voltage according to said voltage adjusting signal.

2. The flicker controlling system of the liquid crystal display device according to claim 1, wherein, in said common potential controlling unit, a switch to set said voltage adjusting signal to be in an output state is attached to a jig and tool mounted in said liquid crystal display device.

3. The flicker controlling system of the liquid crystal display device according to claim 1, wherein, in said common potential controlling unit, a switch to set said voltage adjusting signal to be in an output state is attached to said liquid crystal display device itself.

4. The flicker controlling system of the liquid crystal display device according to claim 1, wherein a driving method for said liquid crystal displaying unit is a frame-inversion driving method in which a polarity of an entire frame is alternately inverted in every one frame.

5. The flicker controlling system of the liquid crystal display device according to claim 1, wherein a driving method for said liquid crystal displaying unit is a line-inversion driving method in which a polarity of each line is alternately inverted on every line and in every one frame.

6. The flicker controlling system of the liquid crystal display device according to claim 1, wherein a driving method for said liquid crystal displaying unit is a dot-inversion driving method in which a polarity of each dot is alternately inverted on every dot and in every one frame.

7. The flicker controlling system of the liquid crystal display device according to claim 1, wherein a driving method for said liquid crystal displaying unit is a 1H2V (1 Horizontal line 2 Vertical lines)-inversion driving method in which a polarity of a driving voltage is alternately inverted for every one horizontal line and every two vertical scanning lines for every one frame period.

8. The flicker controlling system of the liquid crystal display device according to claim 1, wherein a driving method for said liquid crystal displaying unit is a 2H1V (2 Horizontal lines and 1 Vertical line)-inversion driving method in which a polarity of a driving voltage is alternately inverted for every two horizontal lines and every one vertical scanning line for every one frame period.

9. A flicker controlling system of a liquid crystal display device for performing a flicker controlling operation on a liquid crystal displaying unit by using a flicker controlling screen corresponding to a driving method for said liquid crystal displaying unit, comprising:
an input signal pattern judging unit to output a specified signal when judging that data to display said flicker controlling screen is contained in a signal input to said liquid crystal displaying unit and that input timing of data to display said flicker controlling screen matches predetermined timing;
a common potential controlling unit to output a voltage adjusting signal for controlling a common electrode potential of said liquid crystal displaying unit according to said specified signal and, thereafter, to maintain an outputting state of said voltage adjusting signal; and
a common potential outputting unit to set a common electrode potential by supplying a common electrode voltage according to said voltage adjusting signal.

10. The flicker controlling system of the liquid crystal display device according to claim 9, wherein, in said common potential controlling unit, a switch to set said voltage adjusting signal to be in an output state is attached to a jig and tool mounted in said liquid crystal display device.

11. The flicker controlling system of the liquid crystal display device according to claim 9, wherein, in said common potential controlling unit, a switch to set said voltage adjusting signal to be in an output state is attached to said liquid crystal display device itself.

12. The flicker controlling system of the liquid crystal display device according to claim 9, wherein a driving method for said liquid crystal displaying unit is a frame-inversion driving method in which a polarity of an entire frame is alternately inverted in every one frame.

13. The flicker controlling system of the liquid crystal display device according to claim 9, wherein a driving method for said liquid crystal displaying unit is a line-inversion driving method in which a polarity of each line is alternately inverted on every line and in every one frame.

14. The flicker controlling system of the liquid crystal display device according to claim 9, wherein a driving method for said liquid crystal displaying unit is a dot-inversion driving method in which a polarity of each dot is alternately inverted on every dot and in every one frame.

15. The flicker controlling system of the liquid crystal display device according to claim 9, wherein a driving method for said liquid crystal displaying unit is a 1H2V (1 Horizontal line 2 Vertical lines)-inversion driving method in which a polarity of a driving voltage is alternately inverted for every one horizontal line and every two vertical scanning lines for every one frame period.

16. The flicker controlling system of the liquid crystal display device according to claim 9, wherein a driving method for said liquid crystal displaying unit is a 2H1V (2 Horizontal lines and 1 Vertical line)-inversion driving method in which a polarity of a driving voltage is alternately inverted for every two horizontal lines and every one vertical scanning line for every one frame period.

17. A flicker controlling system of a liquid crystal display device for performing a flicker controlling operation on a liquid crystal displaying unit by using a flicker controlling screen corresponding to a driving method for said liquid crystal displaying unit, comprising:
an input signal pattern judging unit to output a specified signal when judging that data to display said flicker controlling screen is contained in a signal input to said liquid crystal displaying unit and that input timing of data to display said flicker controlling screen matches predetermined timing, and that specifications of said liquid crystal displaying unit match product specifications of said liquid crystal display device;
a common potential controlling unit to output a voltage adjusting signal for controlling a common electrode potential of said liquid crystal displaying unit according to said specified signal and, thereafter, to maintain an outputting state of said voltage adjusting signal; and
a common potential outputting unit to set a common electrode potential by supplying a common electrode voltage according to said voltage adjusting signal.

18. The flicker controlling system of the liquid crystal display device according to claim 17, wherein, in said common potential controlling unit, a switch to set said voltage adjusting signal to be in an output state is attached to a jig and tool mounted in said liquid crystal display device.

19. The flicker controlling system of the liquid crystal display device according to claim 17, wherein, in said common potential controlling unit, a switch to set said voltage adjusting signal to be in an output state is attached to said liquid crystal display device itself.

20. The flicker controlling system of the liquid crystal display device according to claim 17, wherein a driving method for said liquid crystal displaying unit is a frame-inversion driving method in which a polarity of an entire frame is alternately inverted in every one frame.

21. The flicker controlling system of the liquid crystal display device according to claim 17, wherein a driving method for said liquid crystal displaying unit is a line-inversion driving method in which a polarity of each line is alternately inverted on every line and in every one frame.

22. The flicker controlling system of the liquid crystal display device according to claim 17, wherein a driving method for said liquid crystal displaying unit is a dot-inversion driving method in which a polarity of each dot is alternately inverted on every dot and in every one frame.

23. The flicker controlling system of the liquid crystal display device according to claim 17, wherein a driving method for said liquid crystal displaying unit is a 1H2V (1 Horizontal line 2 Vertical lines)-inversion driving method in which a polarity of a driving voltage is alternately inverted for every one horizontal line and every two vertical scanning lines for every one frame period.

24. The flicker controlling system of the liquid crystal display device according to claim 17, wherein a driving method for said liquid crystal displaying unit is a 2H1V (2 Horizontal lines and 1 Vertical line)-inversion driving method in which a polarity of a driving voltage is alternately inverted for every two horizontal lines and every one vertical scanning line for every one frame period.

25. A flicker controlling system of a liquid crystal display device for performing a flicker controlling operation on a liquid crystal displaying means by using a flicker controlling screen corresponding to a driving method for said liquid crystal displaying means, comprising:
an input signal pattern judging means to output a specified signal when judging that data to display said flicker controlling screen is contained in a signal input to said liquid crystal displaying means;
a common potential controlling means to output a voltage adjusting signal for controlling a common electrode potential of said liquid crystal displaying means according to said specified signal and, thereafter, to maintain an outputting state of said voltage adjusting signal; and
a common potential outputting means to set a common electrode potential by supplying a common electrode voltage according to said voltage adjusting signal.

26. A flicker controlling system of a liquid crystal display device for performing a flicker controlling operation on a liquid crystal displaying means by using a flicker controlling screen corresponding to a driving method for said liquid crystal displaying means, comprising:
an input signal pattern judging means to output a specified signal when judging that data to display said flicker controlling screen is contained in a signal input to said liquid crystal displaying means and that input timing of data to display said flicker controlling screen matches predetermined timing;
a common potential controlling means to output a voltage adjusting signal for controlling a common electrode potential of said liquid crystal displaying means according to said specified signal and, thereafter, to maintain an outputting state of said voltage adjusting signal; and
a common potential outputting means to set a common electrode potential by supplying a common electrode voltage according to said voltage adjusting signal.

27. A flicker controlling system of a liquid crystal display device for performing a flicker controlling operation on a liquid crystal displaying means by using a flicker controlling screen corresponding to a driving method for said liquid crystal displaying means, comprising:
an input signal pattern judging means to output a specified signal when judging that data to display said flicker controlling screen is contained in a signal input to said liquid crystal displaying means and that input timing of data to display said flicker controlling screen matches predetermined timing, and that specifications of said liquid crystal displaying means match product specifications of said liquid crystal display device;
a common potential controlling means to output a voltage adjusting signal for controlling a common electrode potential of said liquid crystal displaying means according to said specified signal and, thereafter, to maintain an outputting state of said voltage adjusting signal; and
a common potential outputting means to set a common electrode potential by supplying a common electrode voltage according to said voltage adjusting signal.
